(19) United States
(12) Patent Application Publication
(10) Pub. No.: US 2009/0201266 A1
(43) Pub. Date: Aug. 13, 2009

(54) OPERATION INFORMATION INPUT APPARATUS AND ULTRASONIC IMAGING APPARATUS

(76) Inventors: Hiroshi Hashimoto, Tokyo (JP); Yasuyo Saito, Tokyo (JP); Shinichi Amemiya, Tokyo (JP)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/367,016

(22) Filed: Feb. 6, 2009

(30) Foreign Application Priority Data
Feb. 8, 2008 (JP) 2008-028889

(51) Int. Cl. G06F 3/041; G06F 3/048

(52) U.S. Cl. 345/173; 715/773

(57) ABSTRACT

An operation information input apparatus includes a button image display device which displays a button array image with a plurality of button images arranged therein, a touch panel device which is overlaid on a display surface of the button image display device and detects proximity position information indicative of each position in the display surface when an operator approaches the display surface, and a push button identifying unit which identifies each button image that the operator has approached, based on the proximity position information and button position information of the button array image.

### CROSS REFERENCE TO RELATED APPLICATIONS

This application claims the benefit of Japanese Patent Application No. 2008-028889 filed Feb. 8, 2008, which is hereby incorporated by reference in its entirety.

### BACKGROUND OF THE INVENTION

The embodiments described herein relate to an operation information input apparatus and an ultrasonic imaging apparatus each of which inputs operation or control information from a touch panel.

A touch panel has recently been used even in an ultrasonic imaging apparatus to input operation or control information therein. The touch panel has no mechanical contact points at the input of the operation information and is long in lifetime and high in reliability.

With greater functionality of the ultrasonic imaging apparatus, the number of operation information inputted manually by an operator is on the increase. With its increase, the required number of button images displayed on the touch panel is also increasing. Adaptations to such an increase in operation information by upsizing of a display screen, paging of screen information in plural form, and the rearrangement of displayed screen information, etc. have been generally carried out (refer to, for example, Japanese Unexamined Patent Publication No. 2004-070736).

On the other hand, since the ultrasonic imaging apparatus is used at a clinical site such as a bedside, the maneuverability, compactness and controllability of the apparatus have been regarded as important. A touch panel disposed in the neighborhood of an input unit such as a keyboard is also preferably compact and high in controllability. Thus, the button images displayed on the display screen of the touch panel result in ones arranged small and in the high density.

According to the background art, however, the frequency of misinputting of operation information by the operator becomes high and the controllability is reduced. That is, there is a high possibility that since the button images arranged small and in the high density are displayed on the touch panel, an incorrect button image will be selected upon selection of each button image by the operator. Particularly when the size of one button image is equal to or smaller than the size of a finger tip portion of the operator, plural buttons are simultaneously selected upon the operation of selecting these button images arranged in the high density, thus resulting in further difficulty such as the selection of different buttons.

In the ultrasonic imaging apparatus, there is a case in which while the operator brings an ultrasonic probe into intimate contact with a subject with one hand thereof, the operator inputs operation information with another hand thereof. In such an example, it is simple and easy for the operator to contact the touch panel directly by his or her finger tip rather than contact with the touch panel by a pen or the like and to input the operation information.

When, however, the touch panel is small and the button images are arranged in the high density, it is not easy for the operator to contact a targeted button image accurately through the finger tip portion thereof. Inconvenience also occurs in that since the size of the finger tip portion varies depending on operators, the controllability differs depending on the operators. Incidentally, although the operation information can also be displayed in divided form over plural pages in the same size, this is not preferred in terms of the addition of the operation of page selection and operationality.

When medical electronic equipment such as the ultrasonic imaging apparatus or the like is used at the clinical site, there is also a case in which urgency is required upon imaging. In this case, taking time in inputting the intended operation information by the operator leads to the degradation of usability of the ultrasonic imaging apparatus.

It is desirable that the problems described previously are solved.

### BRIEF DESCRIPTION OF THE INVENTION

An operation information input apparatus according to the invention of a first aspect, including: a button image display device which displays a button array image with a plurality of button images arranged therein; a touch panel device which is overlaid on a display surface of the button image display device and detects proximity position information indicative of each position in the display surface when an operator approaches the display surface; and a push button identifying unit which identifies each button image that the operator has approached, based on the proximity position information and button position information of the button array image, wherein the button position information includes information of determination areas each obtained by reducing each button area with the button image located therein in the direction of the center of the button area from a boundary of the button area, and wherein the push button identifying unit performs the identification when the proximity position of the proximity position information is included in the corresponding determination area, and performs the identification when the proximity position thereof is not included in the determination area.

In the invention of the first aspect, each pressed button is identified or specified by its corresponding determination area smaller than the button area.

An operation information input apparatus according to the invention of a second aspect is provided wherein in the operation information input apparatus described in the first aspect, the push button identifying unit includes a button image enlargement device which, when the proximity position of the proximity position information is not included in the determination area, displays the button image located in the neighborhood of the proximity position on the button image display device in enlarged form.

In the invention of the second aspect, the button image is enlarged and each pressed button is easily identified.

An operation information input apparatus according to the invention of a third aspect is provided wherein in the operation information input apparatus described in the second aspect, the push button identifying unit is equipped with an initial image resetting device which, when the input of the proximity position information is not conducted during a predetermined time after execution of the enlargement display, erases the enlargement display and displays the button array image.

In the invention of the third aspect, an initial screen is always set as a button array image and all buttons in the image are selected.

An operation information input apparatus according to the invention of a fourth aspect is provided wherein in the operation information input apparatus described in either the second or third aspect, the push button identifying unit includes an enlargement factor setting device which sets an enlargement factor at the execution of the enlargement display.

In the invention of the fourth aspect, the enlargement factor can be changed.

An operation information input apparatus according to the invention of a fifth aspect is provided wherein in the operation information input apparatus described in any one of the first through fourth aspects, the push button identifying unit includes a re-proximity urging device which urges the operator to re-approach when the proximity position of the proximity position information is not included in the determination area.

In the invention of the fifth aspect, the operator is caused to realize that each pressed button has not been inputted as operation information.

An operation information input apparatus according to the invention of a sixth aspect is provided wherein in the operation information input apparatus described in the fifth aspect, the re-proximity urging device includes a warning sound generation device which produces a warning sound for urging re-proximity.

In the invention of the sixth aspect, reinput is urged by the sound.

An operation information input apparatus according to the invention of a seventh aspect is provided wherein in the operation information input apparatus described in the fifth or sixth aspect, the re-proximity urging device includes a follow-up character generation device which displays a character for urging re-proximity on the button image display device.

In the invention of the seventh aspect, reinput is urged by the displayed character information.

An operation information input apparatus according to the invention of an eighth aspect is provided which includes: a button image display device which displays a button array image with a plurality of button images arranged therein; a touch panel device which is overlaid on a display surface of the button image display device and detects proximity position information indicative of each position in the display surface when an operator approaches the display surface; and a push button identifying unit which identifies each button image that the operator has approached, based on the proximity position information and button position information of the button array image, wherein the push button identifying unit includes a button image enlargement device which displays the button array image on the button image display device in enlarged form simultaneously with a first detection of the proximity position information, which is conducted when the button array image is displayed on the button image display device, and a position information comparing device which identifies each button image that the operator approaches, based on the proximity position information and the button position information of the button array image displayed in enlarged form, simultaneously with a second detection of the proximity position information, which is conducted after the first detection.

In the invention of the eighth aspect, the button array image is displayed in enlarged form by the first input of twice-input proximity position information, and each button image is identified or specified by the second input of the proximity position information.

An operation information input apparatus according to the invention of a ninth aspect is provided wherein in the operation information input apparatus described in the eighth aspect, the push button identifying unit includes an initial image resetting device which, when the second detection is not conduced even when a predetermined time has elapsed after the first detection, stops the enlargement display and displays the button array image again.

In the invention of the ninth aspect, the input of each operation information is always started from the button array image.

An operation information input apparatus according to the invention of a tenth aspect is provided which includes: a button image display device which displays a button array image with a plurality of button images arranged therein; a first touch panel device which is overlaid on a display surface of the button image display device and detects first proximity position information indicative of each position in the display surface when an operator approaches the display surface; a second touch panel device which is overlaid on a panel surface of the first touch panel device and detects second proximity position information indicative of each position in the panel surface when the operator approaches the panel surface; and a push button identifying unit which displays the button array image in enlarged form, based on the first or second proximity position information and identifies each button image that the operator approaches, based on the second or first proximity position information detected after the enlargement display, and button position information of the button array image displayed in enlarged form.

In the invention of the tenth aspect, the button array image is displayed in enlarged form and each proximal or close button image is identified, based on the proximity position information from two touch panels of the first and second touch panel devices.

An operation information input apparatus according to the invention of an eleventh aspect is provided wherein in the operation information input apparatus described in the tenth aspect, the first touch panel device includes a non-contact type first touch panel.

In the invention of the eleventh aspect, the proximity position information of the operator is detected at an early stage prior to the contact of the operator with each touch panel.

An operation information input apparatus according to the invention of a twelfth aspect is provided wherein in the operation information input apparatus described in the eleventh aspect, the second touch panel device includes a contact type second touch panel.

In the invention of the twelfth aspect, the proximity position information of the operator is detected at the position of a finger tip portion brought into contact with each touch panel.

An operation information input apparatus according to the invention of a thirteenth aspect is provided wherein in the operation information input apparatus described in the eleventh aspect, the second touch panel device includes a non-contact type second touch panel.

In the invention of the thirteenth aspect, the first and second touch panels are both configured as a non-contact type.

An operation information input apparatus according to the invention of a fourteenth aspect is provided wherein in the operation information input apparatus described in the thirteenth aspect, the first touch panel device includes a detection signal sorting device which outputs a first proximity signal indicative of proximity of the operator when the magnitude of a detection signal of a touch sensor for detecting the proximity of the operator through the first touch panel exceeds a first threshold value.

An operation information input apparatus according to the invention of a fifteenth aspect is provided wherein in the operation information input apparatus described in the fourteenth aspect, the detection signal sorting device outputs a second proximity signal indicative of proximity of the operator when the magnitude of a detection signal of a touch sensor for detecting the proximity of the operator through the second touch panel exceeds a second threshold value.

An operation information input apparatus according to the invention of a sixteenth aspect is provided wherein in the operation information input apparatus described in the fifteenth aspect, the first threshold value and the second threshold value have different values respectively.

In the invention of the sixteenth aspect, each proximity signal corresponding to the proximal distance of the operator to each touch panel is outputted according to the first and second threshold values.

An operation information input apparatus according to the invention of a seventeenth aspect is provided wherein in the operation information input apparatus described in either the fifteenth aspect or the sixteenth aspect, the detection signal sorting device changes the first and second threshold values according to each position in the display surface.

In the invention of the seventeenth aspect, the first and second threshold values are changed based on the button array image, thereby reliably securing the input of each operation information.

An operation information input apparatus according to the invention of an eighteenth aspect is provided which includes: a button image display device which displays a button array image with a plurality of button images arranged therein; a third touch panel device which is overlaid on a display surface of the button image display device and detects proximity position information indicative of each proximity position in the display surface when an operator approaches the display surface; and a push button identifying unit which identifies each button image that the operator has approached, based on the proximity position information and button position information of the button array image, wherein the third touch panel device includes proximity position detecting unit which determines the proximity position using a touch sensor for detecting the approach on a non-contact basis and a detection signal of the touch sensor, wherein the proximity position detecting unit includes a detection signal sorting device which outputs a third proximity signal indicative of a proximity and a fourth proximity signal at closer proximity than the proximity, and wherein the push button identifying unit includes a button image enlargement device which displays the button array image in enlarged form when the third proximity signal is received, and a position information comparing device which identifies each button image that the operator approaches, based on the proximity position information and the button position information of the button array image displayed in enlarged form.

In the invention of the eighteenth aspect, the magnitude of the detection signal of each touch sensor is selected according to the third and fourth proximity signals corresponding to the proximity distance. As the proximity distance of the operator to each touch panel becomes smaller, the enlargement display of the button array image and the identification of each button image that the operator has approached, are carried out sequentially.

An operation information input apparatus according to the invention of a nineteenth aspect is provided wherein in the operation information input apparatus described in the eighteenth aspect, the detection signal sorting device changes the third threshold value for selecting the third proximity signal and the fourth threshold value for selecting the fourth proximity signal, according to each position in the display surface.

In the invention of the nineteenth aspect, the third and fourth threshold values are changed based on the button array image, thereby reliably ensuring the input of each operation information.

An ultrasonic imaging apparatus according to the invention of a twentieth aspect is provided which includes: an input unit which inputs operation information of an operator therein; a tomographic image acquisition unit which acquires tomographic image information of a subject, based on the operation information; and a display unit which displays the tomographic image information thereon, wherein the input unit includes an operation information input apparatus described in any one of the first through nineteenth aspects.

In the invention of the twentieth aspect, the operation information input apparatus described in any one of the first through nineteenth aspects is included in the input unit. Each button image that the operator has approached is identified or specified by the operation information input apparatus.

According to the embodiments described herein, the selection of each button image displayed on its corresponding touch panel can be performed reliably without imposing a burden on an operator.

Further objects and advantages of the embodiments described herein will be apparent from the following description of the preferred embodiments of the invention as illustrated in the accompanying drawings.

### BRIEF DESCRIPTION OF THE DRAWINGS

FIG. 1 is a block diagram showing an overall configuration of an ultrasonic imaging apparatus.

FIG. 2 is an explanatory diagram illustrating an outer appearance of an operation panel included in the ultrasonic imaging apparatus.

FIG. 3 is a block diagram depicting a configuration of an input unit according to a first embodiment.

FIGS. 4(A) and 4(B0 are explanatory diagrams showing one example illustrative of button images and determination areas used upon identifying the button images.

FIG. 5 is a block diagram showing a configuration of a push button identifying unit according to the first embodiment.

FIG. 6 is a flowchart showing the operation of the input unit according to the first embodiment.

FIG. 7(A) is an explanatory diagram illustrating the manner in which an operator approaches a touch panel, and FIG. 7(B) is an explanatory diagram illustrating one example of an enlarged image after the operator has approached.

FIG. 8 is a block diagram showing a configuration of an input unit according to a second embodiment.

FIG. 9 is a block diagram illustrating a configuration of a push button identifying unit according to the second embodiment.

FIG. 10 is a flowchart showing the operation of the input unit according to the second embodiment.

FIG. 11 is a block diagram illustrating a configuration of an input unit according to a third embodiment.

FIG. 12 is a block diagram showing a configuration of a proximity position detecting part according to the third embodiment.

FIG. 13 is an explanatory diagram illustrating a relationship between a proximity distance of an operator and a change in electrostatic capacitance.

FIG. 14 is a block diagram showing a configuration of a push button identifying unit according to the third embodiment.

FIG. 15 is a flowchart showing the operation of the input unit according to the third embodiment.

### DETAILED DESCRIPTION OF THE INVENTION

Embodiments of an ultrasonic imaging apparatus according to the invention will be explained below with reference to the accompanying drawings. Incidentally, the invention is not limited thereby.

### First Embodiment

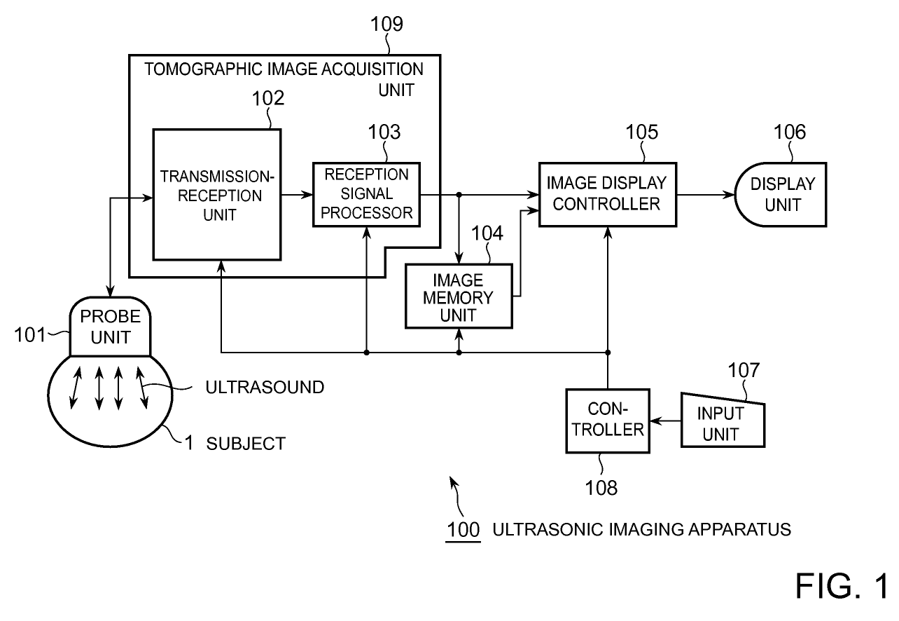

An overall configuration of an ultrasonic imaging apparatus 100 according to the first embodiment will first be described. FIG. 1 is a block diagram showing the overall configuration of the ultrasonic imaging apparatus 100 according to the first embodiment. The ultrasonic imaging apparatus 100 has a probe unit 101, a tomographic image acquisition unit 109, an image memory unit 104, an image display controller 105, a display unit 106, an input unit 107 and a controller 108. The tomographic image acquisition unit 109 includes a transmission-reception unit 102 and a reception signal processor 103.

The probe unit 101 applies ultrasound in a specific direction of a portion or region, i.e., a subject 1 for transmitting and receiving the ultrasound and receives ultrasonic signals reflected from inside the subject 1 as time-series sound rays. Concurrently with it, the probe unit 101 performs electronic scanning while the directions to apply the ultrasound are being switched sequentially. Incidentally, unillustrated piezoelectric transducers are arranged in the probe unit 101 in array form.

The transmission-reception unit 102 is connected to the probe unit 101 by a coaxial cable and performs the generation of an electric signal for driving each piezoelectric transducer of the probe unit 101 and first-stage amplification of each ultrasonic signal received thereat.

The reception signal processor 103 forms tomographic image information from the ultrasonic signal amplified by the transmission-reception unit 102. Specifically processed contents are, for example, delay/addition processing of a received ultrasonic signal, A/D (analog/digital) conversion processing, processing for writing post-conversion digital information to the image memory unit 104 to be described later as image information such as B mode image information, and the like.

The image memory unit 104 is an image memory for storing information such as the B mode image information or the like. The image memory unit 104 stores the B mode image information that changes in time therein along with time information. The image display controller 105 performs display frame rate conversion of the B mode image information generated at the reception signal processor 103, and shape/position control of a displayed image about the B mode image information. The image display controller 105 also performs the display of ROI (region of interest) indicative of a region of interest on the displayed image corresponding to the B mode image.

The display unit 106 displays information subjected to the display frame rate conversion and the shape/position control of the image display by the image display controller 105 visually to the operator by using a CRT (cathode ray tube) or an LCD (liquid crystal display) or the like.

The input unit 107 includes a keyboard, a pointing device and a touch panel or the like and transmits an operation or control signal inputted by the operator to the controller 108. The input unit 107 performs the input of, for example, the setting of the position of an ROI or a pointer or the like positioned on the display image of the display unit 106, and the determination of the ROI position or the designation of the pointer. Incidentally, the details of the input unit 107 will be described later.

The controller 108 controls the operations of the above respective parts of the ultrasonic imaging apparatus, based on the operation information given from the input unit 107 and the program and data stored in advance to cause the display unit 106 to display the B mode image or the like.

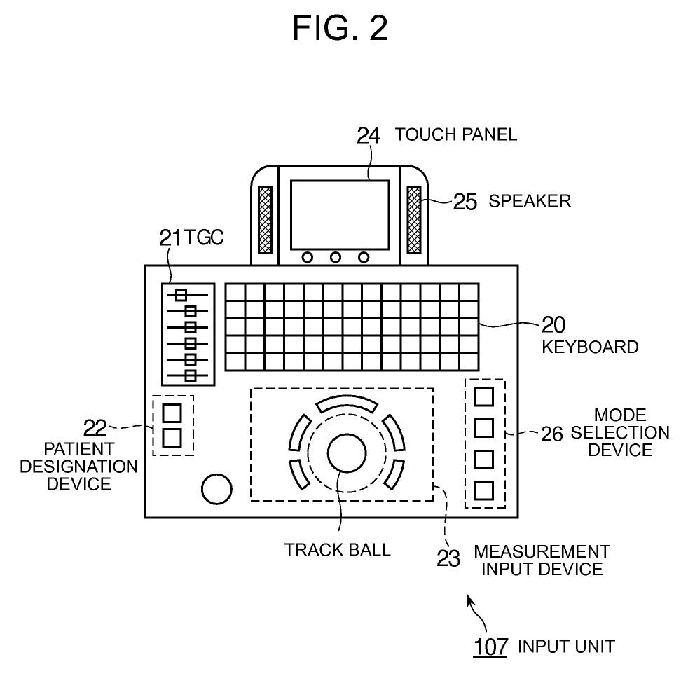

FIG. 2 is an external diagram showing one example of an operation panel included in the input unit 107. The operation panel includes a keyboard 20, a TGC (Time Gain Controller) 21, a patient designation device 22 including a New Patient Key, a measurement input device 23 including a track ball corresponding to a pointing device, a mode selection device 26, a touch panel 24 and a speaker 25, etc.

The TGC 21 adjusts the gain of the displayed tomographic image information as viewed in its depth direction. The patient designation device 22 includes a key selected where the imaging of a new subject is performed. The measurement input device 23 has a key for setting the shape, position and size or the like of ROI where the ROI is set to the display unit 106, and has the function of measuring the pixel values or the like of the set ROI. The mode selection device 26 has a key for selecting an imaging mode such as a B mode, a CFM mode or the like. The touch panel 24 sets a scan parameter value or the like. The speaker 25 produces a Doppler sound or a warning sound or the like to the operator.

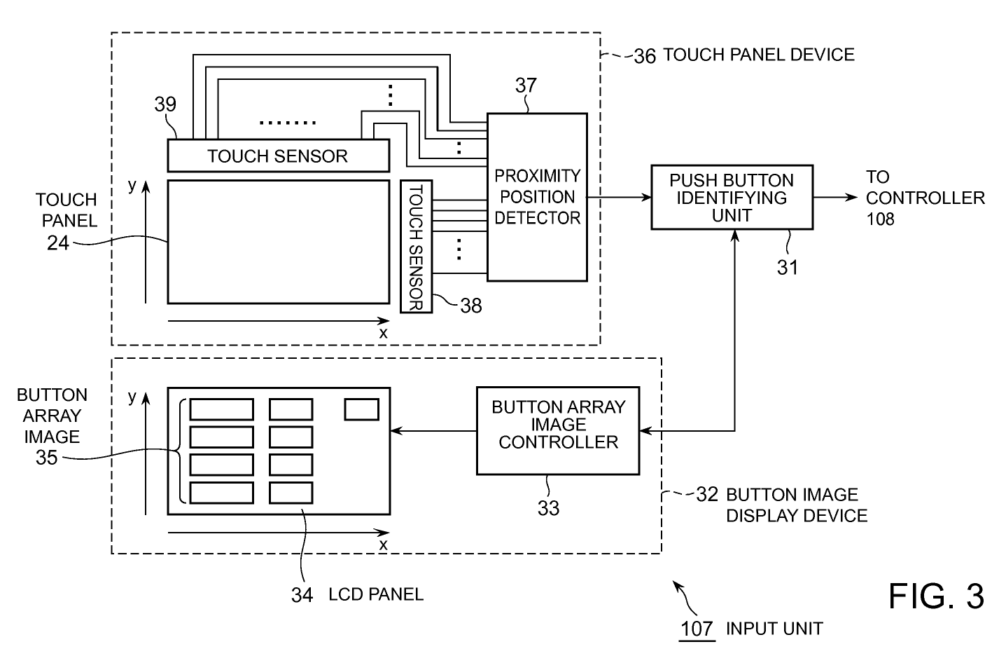

FIG. 3 is a block diagram showing a configuration of a portion related to the touch panel 24 of the input unit 107. The input unit 107 includes a touch panel device 36, a button image display device 32 and a push button identifying unit 31 or the like. The touch panel 36 includes a touch panel 24, an approach or proximity position detector 37, touch sensors 38 and 39. The button image display device 32 includes an LCD panel 34 and a button array image controller 33.

Incidentally, while the touch panel 24 and the LCD panel 34 are respectively displayed at different positions in FIG. 3, the touch panel 24 is placed in a state of being overlaid on the image display surface of the LCD panel 34. Since the touch panel 24 is of a transparent panel in the overlaid state, a button array image 35 displayed on the LCD panel 34 can be visually identified through the touch panel 24.

The touch sensors 38 and 39 generate detection signals at approach or proximity positions as viewed in a y-axis direction and an x-axis direction respectively indicative of the vertical and horizontal directions of the touch panel 24 when the operator approaches the touch panel 24. Here, the proximity indicates a state in which the operator approaches or contacts the touch panel 24. As the touch sensors 38 and 39, there is known an electrostatic capacitance type which is comprised of, for example, transparent electrodes arranged in array form in the x-axis and y-axis directions over the frontal surface and back surface of the touch panel 24 and detects a change in electrostatic capacitance generated between the transparent electrodes on the frontal surface and back surface thereof. In the case of this electrostatic capacitance type, the change in the electrostatic capacitance is defined as a detection signal indicating that a finger tip portion of the operator has approached.

The proximity position detector 37 detects a change in capacitance while the transparent electrodes arranged in the x-axis and y-axis directions arranged on the frontal and back surfaces for measuring the change in capacitance are being switched sequentially. Each position in the x-axis and y-axis directions where the change in capacitance has occurred is outputted to the push button identifying unit 31 as proximity position information.

The LCD panel 34 is of a liquid crystal display panel and displays the button array image 35 in which button images are arranged. The button array image controller 33 causes the LCD panel 34 to display a button array image and transmits button position information to the push button identifying unit 31 simultaneously with it.

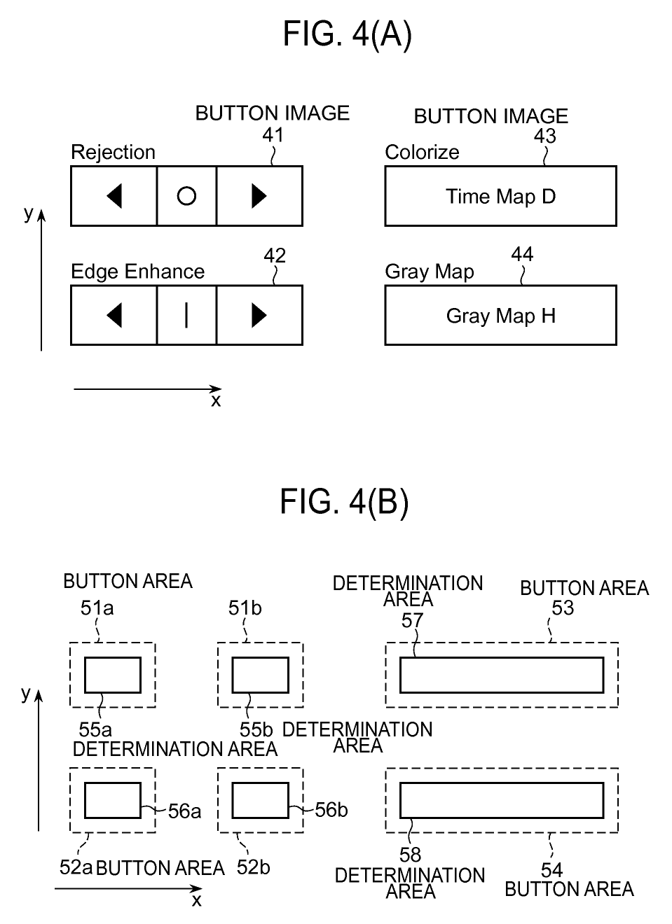

FIG. 4 is an explanatory diagram showing the button images displayed in the button array image 35 and button position information about the button images. FIG. 4(A) is a diagram showing button images 41 through 44 indicative of one example of the button array image 35. In the button images 41 and 42, the numeric values to be set rises or falls by allowing symbols A thereof to be pressed with the finger tip portion of the operator or to approach the finger tip portion thereof. In the button images 43 and 44, the functions of “Time Map D” and “Gray Map H” are selected by pressing the button images with the finger tip portion of the operator or allowing the finger tip portion to approach the same.

FIG. 4(B) illustrates the button position information transmitted to the push button identifying unit 31, of the button images 41 through 44 shown in FIG. 4(A). Button areas 51a and 51b and 52a and 52b indicated by broken lines in FIG. 4(B) respectively coincide with the positions of rectangular image areas in which the symbols A of the button images 41 and 42 exist. Button areas 53 and 54 indicated by broken lines in FIG. 4(B) respectively coincide with the positions of rectangular image areas in which the button images 43 and 44 exist.

Determination areas 55 through 58 comprised of boundary lines indicated by solid lines respectively exist inside the button areas 51 through 54. The determination areas 55 through 58 have boundary lines obtained by reducing or moving the boundary lines of the button areas 51 through 54 in their center directions by predetermined distances respectively. Here, the button position information transmitted from the button array image controller 33 to the push button identifying unit 31 are of position information in the x-axis and y-axis directions, of the determination areas 55 through 58 indicated by the solid lines.

Incidentally, the size reduced to the determination area from each button area is determined experimentally in consideration of the size of each button area, the size of the finger tip portion of the operator and the position accuracy of the proximity position information or the like. As the size of each button area becomes smaller for the most part, the proportion of area occupied by each determination area to its corresponding button area becomes small, and each button image at a reliably approximated position is identified or specified.

The push button identifying unit 31 identifies an approximated button, based on the proximity position information outputted from the proximity position detector 37 and the button position information outputted from the button array image controller 33.

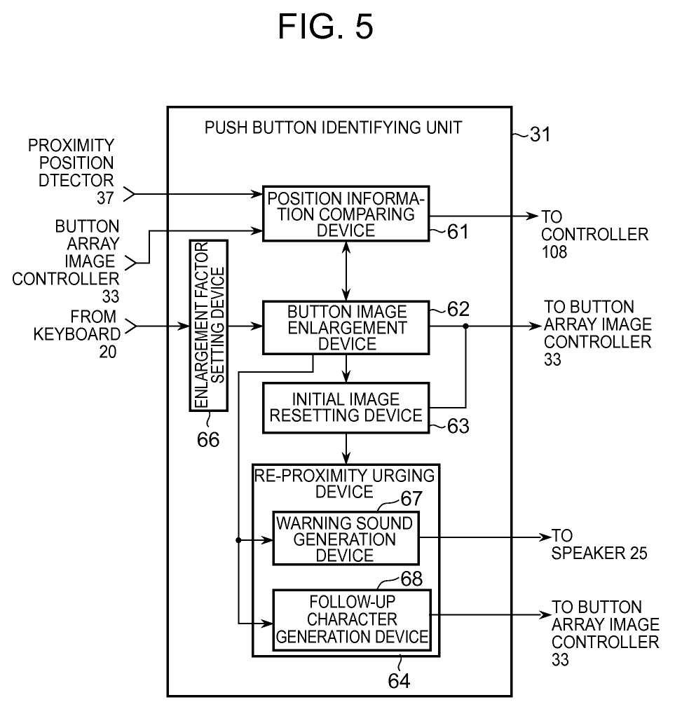

FIG. 5 is a block diagram showing a configuration of the push button identifying unit 31. The push button identifying unit 31 includes a position information comparing device 61, a button image enlargement device 62, an initial image resetting device 63, a re-proximity urging device 64 and an enlargement factor setting device 66. The re-proximity urging device 64 includes a warning sound generation device 67 and a follow-up character generation device 68. The functions and operations of the position information comparing device 61, the button image enlargement device 62, the initial image resetting device 63, the re-proximity urging device 64 and the enlargement factor setting device 66 will be explained in detail in the section of the operation of the input unit 107 to be shown next.

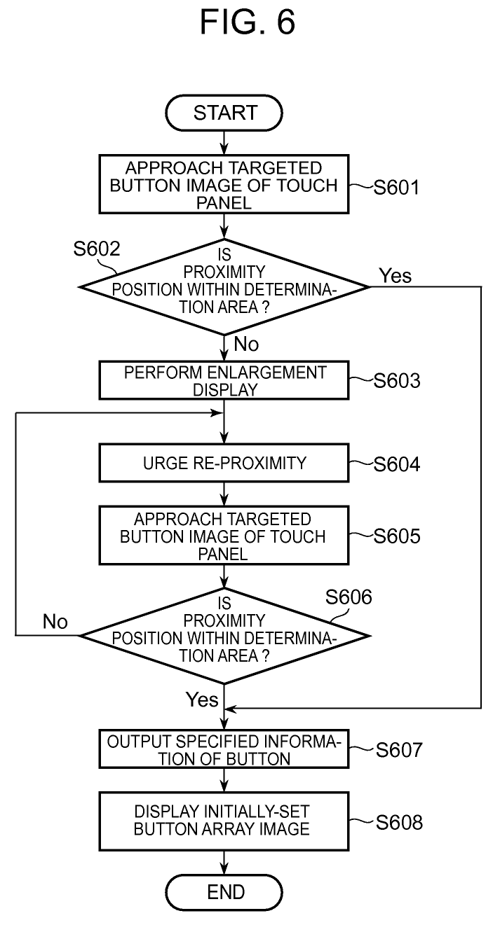

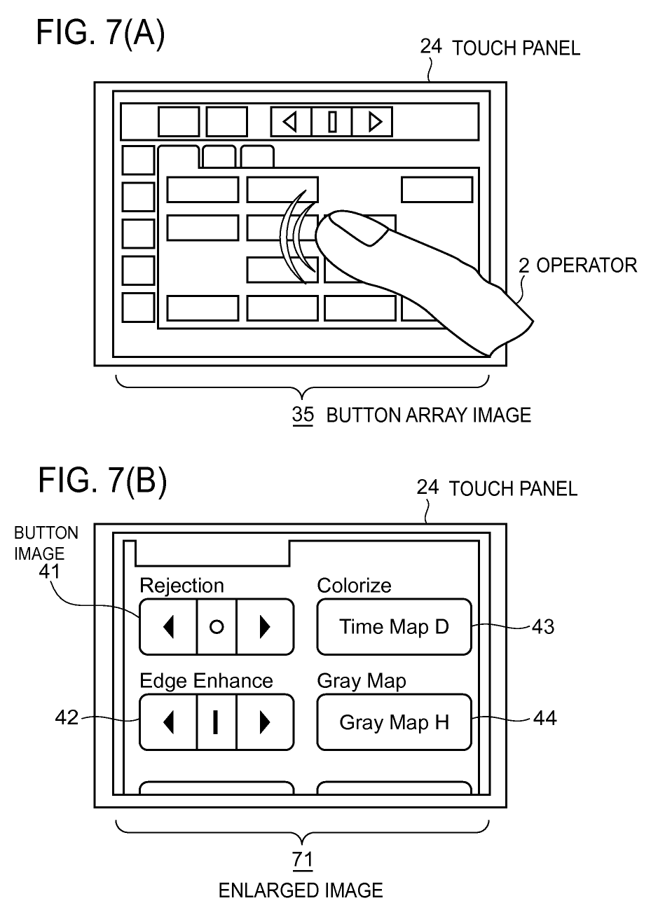

The operation of the input unit 107 will next be described using FIG. 6. FIG. 6 is a flowchart showing the operation of the input unit 107. An operator 2 causes a finger tip portion thereof to approach a targeted button image of the touch panel 24 (Step S601). FIG. 7(A) is an explanatory diagram showing the manner in which the finger tip portion of the operator 2 approaches. A button array image 35 is displayed on the back surface of the touch panel 24. A number of button images are arranged in the button array image in a high density.

The finger tip portion of the operator 2, which approaches the corresponding button image and which pushes the button image or is close to the button image, is illustrated in FIG. 7(A). The operator 2 presses or pushes the intended button image through the finger tip portion thereof. Each button image and the mutual distances between the button images are equal to or smaller than the finger tip portion of the operator 2 in magnitude.

Referring back to FIG. 6 subsequently, the position information comparing device 61 determines whether the proximity position of the operator 2 is included in the corresponding determination area of a button image (Step S602). The position information comparing device 61 compares proximity position information from the touch panel device 36 and button position information from the button image display device 32. The position information comparing device 61 determines whether the proximity position of the proximity position information is included in the corresponding determination area of each button such as indicated by the solid line in FIG. 4(B). Here, each determination area shown in FIG. 4(B) is defined as an area which exists inside as viewed in the direction of the center of each button area corresponding to the button image and is limited to the neighborhood of the center of the button area. Thus, it is possible to detect each error-free reliable button image even though an error in the detection of the detected proximity position information, including an error produced due to the size of the finger tip portion is taken into consideration.

When the proximity position of the operator 2 is not included in the corresponding determination area of the button image (No at Step S602), the position information comparing device 61 does not identify the button image because unclarity remains in the proximity position information, and transmits this information to the button image enlargement device 62 thereby to display the button array image 35 in enlarged form (Step S603). Since the proximity position of the finger tip portion of the operator 2 exists in a non-determination area where each button image cannot be specified, the button image enlargement device 62 displays the button array image 35 in enlarged form and identifies the corresponding button image reliably.

The button image enlargement device 62 displays, for example, an image multiplied by a predetermined enlargement factor, e.g., set to a double enlargement with the proximity position in the button array image 35 as the center in such a manner that this center assumes the proximity position. FIG. 7(B) is an explanatory diagram showing an enlarged image 71 obtained by enlarging the button array image 35 to approximately twice where the proximity position of the operator 2 shown in FIG. 7(A) exists in a non-determination area of each button image. Each button image located in the neighborhood of the proximity position of the button array image 35 is displayed in the enlarged image 71 in enlarged form. With its enlargement, the button position information of the position information comparing device 61 is assumed to have been enlarged in like manner.

Thereafter, the re-proximity urging device 64 urges re-proximity using the speaker 25 or touch panel 24 or the like (Step S604). When a warning sound for urging the re-proximity is produced, the re-proximity urging device 64 uses the warning sound generation device 67. The warning sound generation device 67 causes the speaker 25 to produce the warning sound and thereby urges the operator 2 to perform re-proximity. When the display for urging the re-proximity is performed, the re-proximity urging device 64 uses the follow-up character generation device 68. The follow-up character generation device 68 displays follow-up or urged characters on the touch panel 24 to urge the operator 2 to approach again.

Thereafter, the operator 2 causes the finger tip portion thereof to approach a targeted button image of the enlarged image 71 displayed on the touch panel 24 again (Step S605). Here, since the determination areas 55 through 58 of the position information comparing device 61 are also enlarged in the enlarged image 71 including the button images 41 through 44, the influence of a detected error due to the size of the finger tip portion and a detected error contained in the proximity position information is reduced.

Thereafter, the position information comparing device 61 determines whether the proximity position of the operator 2 is included in the determination region of each button image (Step S606). When the proximity position is found not to be included in the determination area (No at Step S606), the push button identifying unit 31 proceeds to Step S604 and performs the urging of re-proximity. When the proximity position is found to be included in the determination area (Yes at Step S606), the push button identifying unit 31 outputs identified or specified information about each button image having the determination area, e.g., a code number and the like to the controller 108 (Step S607).

Thereafter, the push button identifying unit 31 stops the enlargement display of the touch panel 24, displays the initially-set button array image 35 (Step S608), after which the present processing is terminated.

In the first embodiment as described above, the position information of the determination area located inside as viewed in the direction of the center of the image area of each button image is set as the button position information. When the proximity position information of the touch panel 24 by the operator 2 is not included in the determination area, the enlarged image 71 in the button array image 35 is displayed and the proximity is urged again. It is therefore possible to prevent a button error input without imposing a burden on the operator 2 and perform the input of a targeted button reliably.

Although the enlargement factor of the enlarged image 71 is set to the predetermined value in the first embodiment, the enlargement factor or magnification of the button image enlargement device 62 can also be varied by providing the enlargement factor setting device 66 separately. The enlargement factor setting device 66 sets numerical information inputted from the keyboard 20 to the button image enlargement device 62 as an enlargement factor or magnification. The button image enlargement device 62 performs an enlargement display using the enlargement factor. Thus, the operator 2 is able to enlarge the button array image 35 to a reliably inputable size.

In the first embodiment, the button image enlargement device 62 has displayed the image 71 enlarged with the proximity position in the button array image 35 as the center in such a manner that the center thereof assumes the proximity position. However, the center thereof can also be set to the center of the display screen.

Although the first embodiment has shown the example in which the touch panel device 36 has utilized the non-contact electrostatic capacitance type touch sensor as the touch panel, a touch panel having a touch sensor for detecting a proximity position optically and a contact type touch sensor using a resistive film or an ultrasonic surface acoustic wave or the like can also be used.

Although when the finger tip portion of the operator 2 approaches the touch panel 24 and this proximity position is not included in the determination area of each button image, the button array image 35 is displayed in enlarged form in the first embodiment, the button array image 35 can also be displayed in enlarged form regardless of whether the proximity position thereof is included in the determination area of each button image.

In this case, the enlargement display is performed upon a first detection for allowing the finger tip portion to approach the button array image 35, whereas upon a second detection for causing the finger tip portion to approach the button array image 35 displayed in enlarged form, the closed or approximated button image is specified or identified. The button array image 35 displayed in enlarged form is switched to the display of the button array image 35 by the initial image resetting device 53 after a predetermined period of time has elapsed.

### Second Embodiment

On the other hand, although when the position proximal to the touch panel inputted by the operator is not included in the corresponding determination area of each button image, the button array image has been enlarged in the first embodiment, the button array image can also be displayed automatically in enlarged form when the finger tip portion of the operator is approaching the touch panel. With the foregoing in view, a second embodiment will show a case in which a finger tip portion of an operator which is approaching a touch panel is detected and a button array image is displayed in enlarged form in sync with this detection.

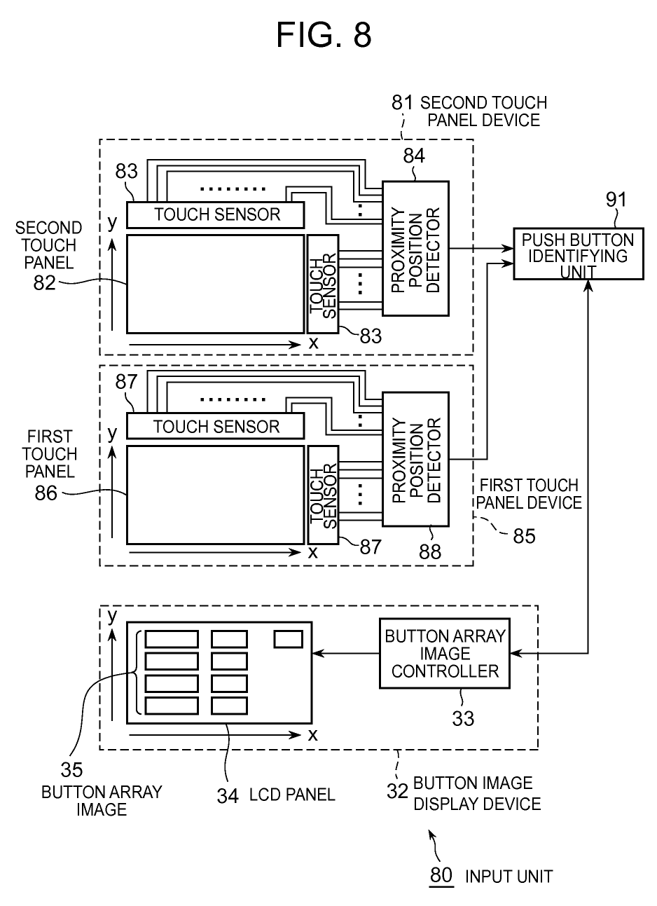

FIG. 8 is a block diagram showing a configuration of an input unit 80 according to the second embodiment. The input unit 80 corresponds to the input unit 107 described in the first embodiment. The second embodiment is exactly the same as the ultrasonic imaging apparatus 100 in other configuration. The input unit 80 includes a first touch panel device 85, a second touch panel device 81, a button image display device 32 and a push button identifying unit 91. Since the button image display device 32 is exactly the same as one shown in the first embodiment, its description will be omitted. The first touch panel device 85 includes a first touch panel 86, touch sensors 87 and a proximity position detector 88. The second touch panel device 81 includes a second touch panel 82, touch sensors 83 and a proximity position detector 84.

The first touch panel device 85 includes a non-contact touch panel that detects a proximity position where the operator approaches the first touch panel 86. The non-contact touch panel includes, for example, an electrostatic capacitance type touch panel and has touch sensors 87 in which lattice-like transparent electrodes orthogonal to one another are arranged on the frontal and back surfaces included in the first touch panel 86 comprised of glass or the like. Each of the touch sensors 87 detects a capacitance change that occurs between the transparent electrodes placed on the frontal and back surfaces, without waiting for contact when the finger tip portion of the operator approaches the plate surface. The proximity position detector 84 detects the position of the touch sensor 87 at which the change in capacitance has occurred, and outputs it to the push button identifying unit 91 as first proximity position information. As the non-contact touch panel, there can also be used one that optically detects proximity position information using photodiodes or the like as the touch sensors 87.

The second touch panel device 81 is of a contact touch panel that detects a proximity position where the operator approaches the second touch panel 82. This contact touch panel is of, for example, a resistive film type having lattice-like transparent electrodes orthogonal to one another over the frontal and back surfaces included in the film-like second touch panel 82. In the transparent electrodes, contact points occur between the frontal and back surfaces due to the approach of the operator. The proximity position detector 84 detects a proximity position from a division ratio based on the resistances of the transparent electrodes and outputs it to the push button identifying unit 91 as second proximity position information.

Incidentally, while the first touch panel 86, second touch panel 82 and LCD panel 34 are arranged vertically in FIG. 8, the second touch panel 82, first touch panel 86 and LCD panel 34 are actually overlaid on one another in this order, and the button array image 35 displayed on the LCD panel 34 is identified visually through the transparent second touch panel 82 and first touch panel 86.

The push button identifying unit 91 performs an enlargement display of the button array image 35 and the identification of an approximated button image, based on the first and second proximity position information from the first touch panel device 85 and the second touch panel device 81.

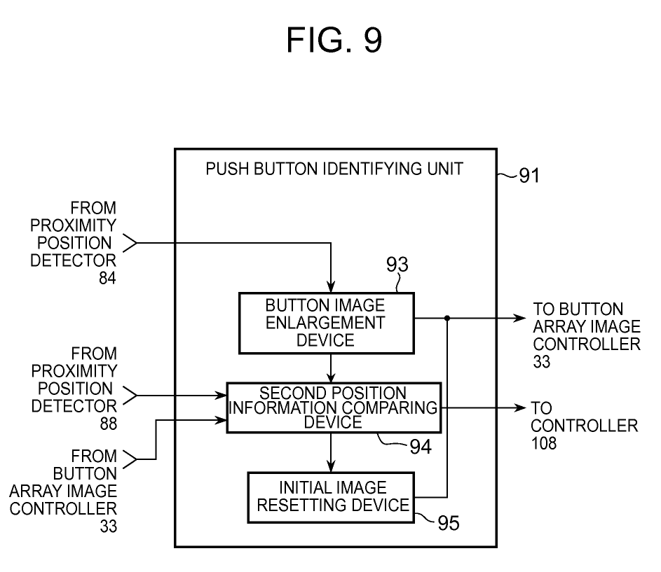

FIG. 9 is a block diagram showing a configuration of the push button identifying unit 91. The push button identifying unit 91 includes a button image enlargement device 93, a second position information comparing device 94 and an initial image resetting device 95. Incidentally, the functions and operations of the button image enlargement device 93, a second position information comparing device 94 and an initial image resetting device 95 will be explained in the second of the operation of the input unit 80 to be continued below.

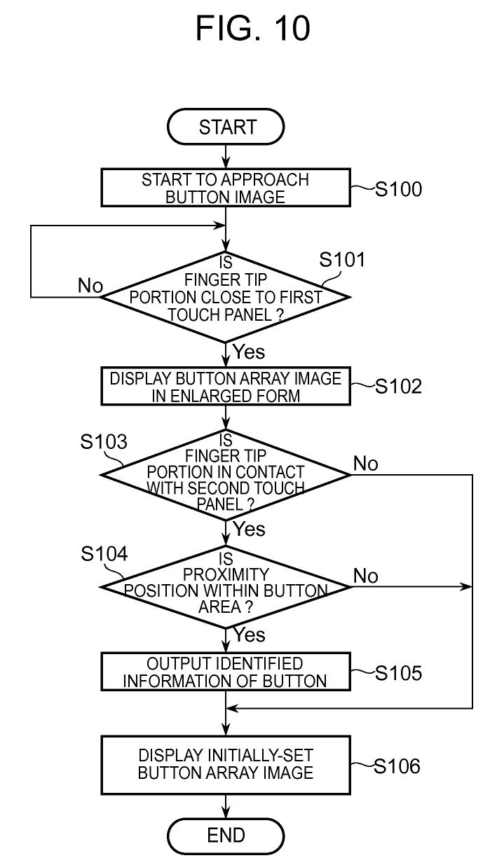

The operation of the input unit 80 will next be explained using FIG. 10. FIG. 10 is a flowchart showing the operation of the input unit 80. The operator 2 first starts to approach the targeted button image of the button array image 35 (Step S100). Here, the finger tip portion of the operator 2 approaches its corresponding position on the second touch panel 82 on which the targeted button image exists, in a manner similar to the case shown in FIG. 7(A).

Thereafter, the proximity position detector 88 of the first touch panel device 85 determines whether the finger tip portion of the operator 2 approaches the non-contact first touch panel 86 (Step S101). When the finger tip portion is found not to approach (No at Step S101) here, the proximity position detector 88 repeats the decision of Step S101 until the finger tip portion approaches.

When the finger tip portion is found to have approached (Yes at Step S101), the proximity position detector 88 outputs first proximity position information about this finger tip portion to the button image enlargement device 93. The button image enlargement device 93 displays in enlarged form the button array image 35 displayed on the LCD panel 34, based on the first proximity position information (Step S102). Here, the button image enlargement device 93 displays in enlarged form the button array image 35 at a predetermined enlargement factor, e.g., a double enlargement with the proximity position indicated by the first proximity position information as the center. An image similar to the enlarged image 71 shown in FIG. 7(B) is displayed on the LCD panel 34 in enlarged form. Incidentally, since the button image enlargement device 93 displays the enlarged image with the proximity position as the center, the operator 2 is able to further approach the targeted button image without moving the finger tip portion greatly.

Thereafter, the proximity position detector 84 of the second touch panel device 81 determines whether the finger tip portion of the operator 2 contacts the contact-type second touch panel 82 (Step S103). When the finger tip portion of the operator 2 has contacted the second touch panel 82 (Yes at Step S103), the proximity position detector 84 outputs second proximity position information to the second position information comparing device 94, and the second position information comparing device 94 determines whether the proximity position of the second proximity position information is included in such button areas 51 through 54 as shown in FIG. 4(B), which are shown in the button position information (Step S 104). When the proximity position exists in the button areas 51 through 54 (Yes at Step 104), the second position information comparing device 94 identifies or specifies a button image in which the proximity position exists, and transmits this specified information, e.g., a code number for the button image, or the like to its corresponding controller 108 (S105).

Thereafter, the initial image resetting device 95 displays the unenlarged initially-set button array image 35 on the LCD panel 34 (Step S106).

When the finger tip portion of the operator 2 is found not to contact the first touch panel 86 (No at Step S103) and the proximity position of the finger tip portion is found not to exist in the button areas 51 through 54 (No at Step S104), the second position information comparing device 94 proceeds to Step 106, where the button array image 35 is displayed on the LCD panel 34 and the present processing is terminated.

In the second embodiment as described above, the non-contact type first touch panel device 85 and the contact type second touch panel device 81 are provided so as to be overlaid on the LCD panel 34. The button array image 35 is enlarged based on the first proximity position information detected by the first touch panel device 85. Further, the close or approximated button is specified based on the second proximity position information in which the button position in the enlarged image 71 is detected by the second touch panel device 81. It is therefore possible to reliably identify the button in one proximity operation at which the button is pressed, and to input the operation or control information.

Although the second touch panel device 81 is set to the contact type in the second embodiment, the non-contact type touch panel can also be used for the second touch panel device 81. In this case, the proximity position detector 84 of the second touch panel device 81 detects a state in which the finger tip portion is closer to the touch panel, as compared with the first touch panel device 85. That is, the proximity position detecting unit 88 and 84 respectively have a detection signal sorting device which limit the proximity information from the touch sensors, e.g., the magnitude of a change in capacitance to ones that exceed first and second threshold values. By making the second threshold value greater than the first threshold value, for example, the second touch panel device is capable of detecting the finger tip portion placed in the state of being closer than the first touch panel device. Incidentally, an example in which each proximity position detector is provided with a similar detection signal sorting device, will be explained in detail in a third embodiment to be described later.

Although when each button image is identified or specified at Step S104, the proximity position information is compared with each button area of the button array image displayed in enlarged form in the second embodiment, it can also be compared with the determination area of each button image described in the first embodiment as an alternative to the button area.

In the second embodiment, the button image enlargement device 93 has displayed the enlarged image 71 enlarged with the proximity position in the button array image 35 as the center in such a manner that the center thereof assumes the proximity position. However, the center thereof can also be set to the center of the display screen.

### Third Embodiment

On the other hand, although the approach and contact of each finger tip portion of the operator 2 have been detected using the two touch panels placed in overlaid form in the second embodiment, the magnitudes of detection signals of finger tip portions, which are detected at a non-contact type single touch panel device, are sorted according to plural threshold values, and the approach and contact of each finger tip portion to the touch panel can also be detected. With the foregoing in view, a third embodiment will show a case in which a proximity position detector is provided with a detection signal sorting device to determine the distance of each finger tip portion proximal to the touch panel according to the magnitude of each detection signal, whereby a button array image 35 is displayed in enlarged form and each button image is identified.

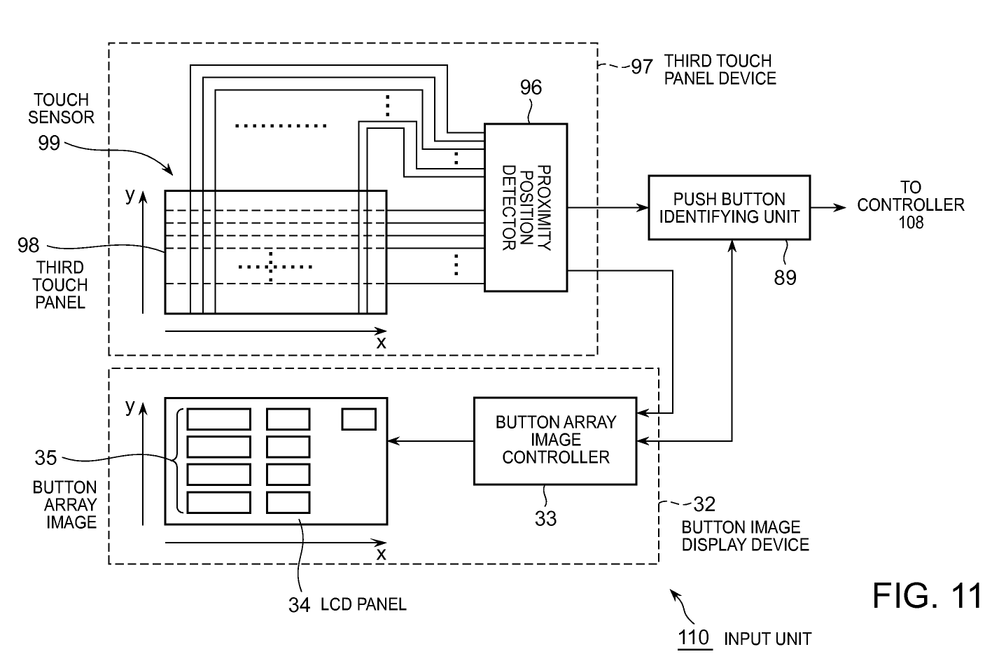

FIG. 11 is a block diagram showing a configuration of an input unit 110 according to the third embodiment. The input unit 110 corresponds to the input unit 107 described in the first embodiment. Since the present embodiment is exactly the same as the ultrasonic imaging apparatus 100 in other configuration, its description will be omitted.

The input unit 110 includes a third touch panel device 97, a button image display device 32 and a push button identifying unit 89. Since the button image display device 32 is exactly the same as one shown in the first embodiment, its description will be omitted.

The third touch panel device 97 includes a third touch panel 98, touch sensors 99 and a proximity position detector 96. The third touch panel 98 and the touch sensors 99 are similar to the non-contact type first touch panel 86 and touch sensors 87 shown in the second embodiment. Incidentally, the electrostatic capacitance type touch sensors 99 including transparent electrodes arranged in strip form in x-axis and y-axis directions on the frontal and back surfaces of the third touch panel 98 of FIG. 11 are illustrated in the third touch panel 98 by solid and broken lines. Each of the touch sensors 99 detects a change in capacitance that occurs between the transparent electrodes of the frontal and back surfaces, which is caused by the approach of the finger tip portion to each touch panel.

Although the third touch panel 98 and the LCD panel 34 are illustrated side by side in FIG. 11, they are actually disposed on the same surface in overlaid form. The button array image 35 displayed on the LCD panel 34 is visually identified through the third touch panel 98.

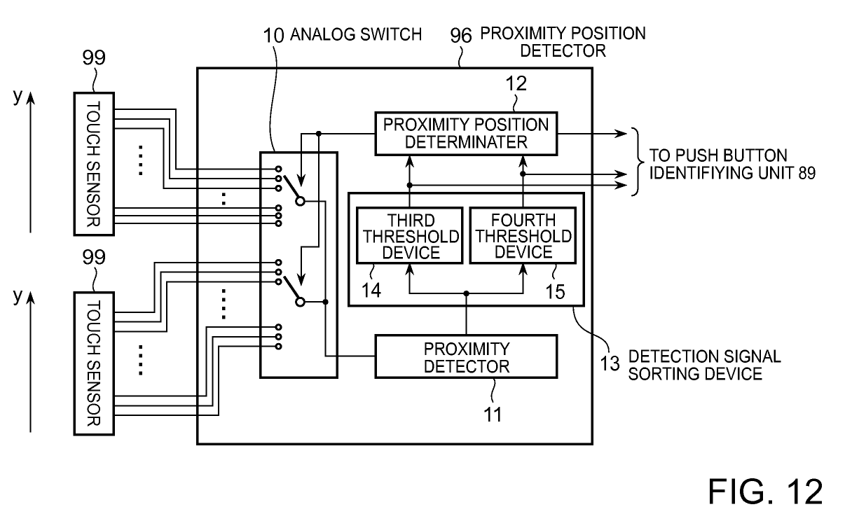

FIG. 12 is a block diagram showing a configuration of the proximity position detector 96. The proximity position detector 96 includes an analog switch 10, a proximity detector 11, a detecting signal sorting device 13 and a proximity position determinater 12. The analog switch 10 performs switching between selection positions of the transparent electrodes that constitute the touch sensors 99, which are oriented in the x-axis and y-axis directions. Incidentally, the present switching is repeatedly conducted with respect to all combinations of the transparent electrodes lying on the frontal and back surfaces.

The proximity detector 11 detects each electrostatic capacitance between the transparent electrodes existent in the frontal and back surfaces, which are selected by the analog switch 10, and determines a change in capacitance from a predetermined value of the electrostatic capacitance. The proximity detector 11 determines the electrostatic capacitance between the transparent electrodes according to the measurement of the time required for the voltage between the transparent electrodes to reach a predetermined voltage where, for example, a constant current flows between the transparent electrodes of the frontal and back surfaces. The predetermined value of the electrostatic capacitance is set as an electrostatic capacitance value included in each transparent electrode between the frontal and back surfaces where ones close to the third touch panel 98 do not exist.

The detection signal sorting device 13 includes a third threshold device 14 and a fourth threshold device 15. The third threshold device 14 compares capacitance change information transmitted from the proximity detector 11 with a third threshold value indicative of the pre-set magnitude of change in capacitance. When the value of the capacitance value information exceeds the third threshold value, the third threshold device 14 determines that each finger tip portion of the operator 2 has approached the third touch panel 98, and outputs proximity information to the proximity position determinater 12 and button array image controller 33. The fourth threshold device 15 compares the capacitance change information transmitted from the proximity detector 11 with a fourth threshold value indicative of the pre-set magnitude of change in capacitance. When the value of the capacitance change information exceeds the fourth threshold value, the fourth threshold device 15 determines that the finger tip portion of the operator 2 has approached the third touch panel 98, and outputs contact information to the proximity position determinater 12.

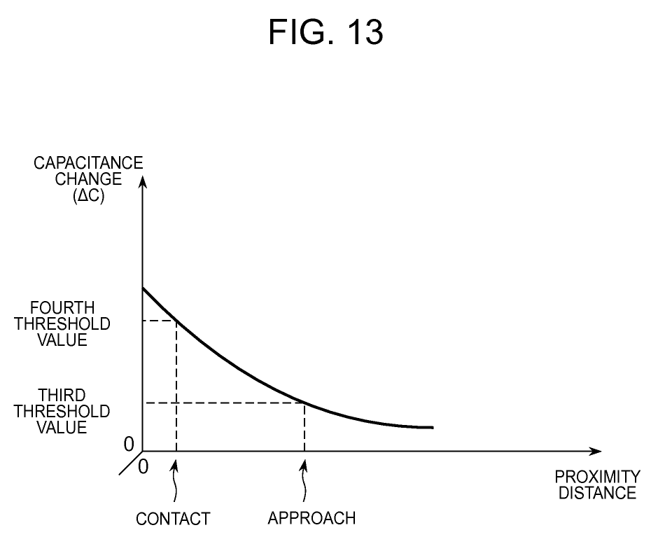

FIG. 13 is an explanatory diagram showing the manner in which the finger tip portion of the operator 2 approaches the third touch panel 98 and the magnitude of a capacitance change AC detected by the proximity detector 11 changes. The horizontal axis indicates a proximity distance corresponding the distance between the finger tip portion of the operator 2 and its corresponding touch panel. The vertical axis indicates the magnitude of the capacitance change AC. The magnitude of the capacitance change AC becomes large gradually as the finger tip portion approaches the third touch panel 98.

Third and fourth threshold values determined experimentally are shown in FIG. 13. The third threshold value is of a value at which when a change in capacitance exceeds this value, the finger tip portion approaches its corresponding touch panel. The fourth threshold value has a value larger than the third threshold value and is of a value at which when the change in capacitance exceeds this value, the finger tip portion is brought into contact with the touch panel.

The proximity position determinater 12 transmits a switching signal of the analog switch 10, corresponding to a control signal indicative of the position for detection of the capacitance change to the analog switch 10, whereas when proximity information and contact information about the finger tip portion from the third threshold device 14 and the fourth threshold device 15 are inputted, the proximity position determinater 12 outputs this switching signal information to the push button identifying unit 89.

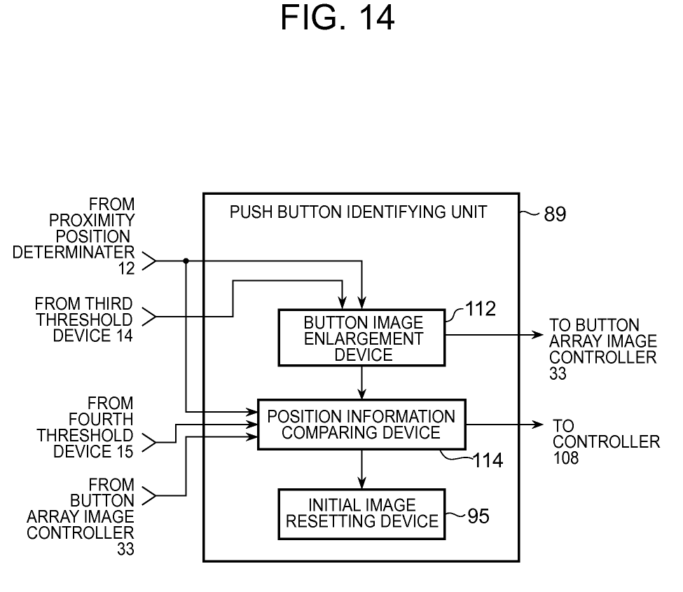

FIG. 14 is a block diagram showing a configuration of the push button identifying unit 89. The push button identifying unit 89 includes a button image enlargement device 112, a position information comparing device 114 and an initial image resetting device 95. Incidentally, the functions and operations of the button image enlargement device 112, the position information comparing device 114 and the initial image resetting device 95 will be explained in the section of the operation of the input unit 110 to be described later.

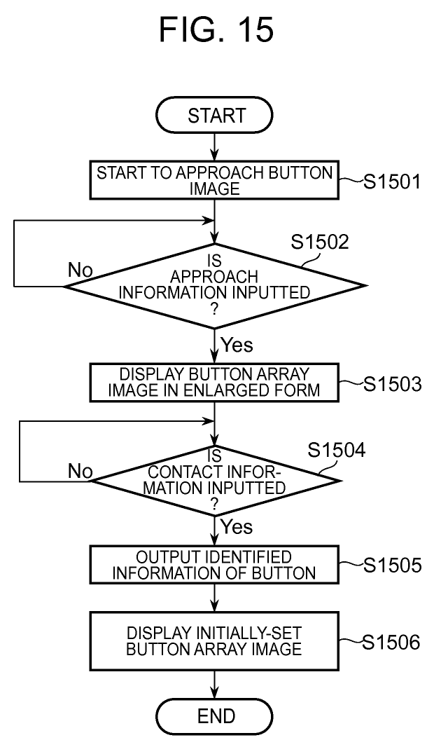

The operation of the input unit 110 will next be explained using FIG. 15. FIG. 15 is a flowchart showing the operation of the input unit 110. The operator 2 starts to approach the targeted button image of the third touch panel 98 (Step S1501). The finger tip portion of the operator 2 approaches its corresponding position on the third touch panel 98 on which the targeted button image exists, in a manner similar to the case shown in FIG. 7(A).

Thereafter, the proximity position determinater 12 determines whether the approach or proximity information is inputted from the third threshold device 14 (Step S1502). When the proximity information is not inputted from the third threshold device 14 here (No at Step S1502), the proximity position determinater 12 repeats the decision of Step S1502 until the finger tip portion of the operator 2 approaches.

When the proximity or approach information is inputted from the third threshold device 14 (Yes at Step S1502), the proximity position determinater 12 outputs proximity position information to the button image enlargement device 112. The button image enlargement device 112 instructs the button array image controller 33 to perform an enlargement display, based on the approach information from the third threshold device 14 and the received proximity position information and displays the button array image 35 displayed on the LCD panel 34 in enlarged form (Step S1503). Here, the button array image controller 33 enlarges the button array image 35 to a predetermined factor or magnification, e.g. twice with the proximity position indicated by the proximity position information as the center and displays the same in such a manner that the center assumes the proximity position. Such an enlarged image 71 as shown in FIG. 7(B) is displayed on the LCD panel 34. Since the button array image controller 33 enlarges this image with the proximity position as the center, the operator 2 is able to contact the intended button image without moving its finger tip portion greatly. The button image enlargement device 112 outputs information about the enlargement display to the position information comparing device 114 simultaneously. The position information comparing device 114 acquires position information of the enlarged button image from the button array image controller 33, based on the outputted information.

Thereafter, the proximity position determinater 12 determines whether the contact information of the finger tip portion is inputted from the fourth threshold device 15 (Step S1504). When it is determined that no contact information is inputted from the fourth threshold device 15 (No at Step S1504), the proximity position determinater 12 repeats the decision of Step S1504 until the finger tip portion of the operator 2 contacts.

When the contact information is inputted from the fourth threshold device 15 (Yes at Step S1504), the proximity position determinater 12 outputs proximity position information to the position information comparing device 114. The position information comparing device 114 compares the two position information corresponding to the proximity position information and the button position information, identifies or specifies each button image located at the proximity position and outputs the so-identified information to the controller 108 (Step S1505). For example, the position information comparing device 114 identifies or specifies such button areas 51 through 54 or determination areas 55 through 58 as shown in FIG. 4(B) and transmits code information indicative of the specified button to the controller 108.

Thereafter, the initial image resetting device 95 displays the unenlarged initially-set button array image 35 on the LCD panel 34 (Step S1506), and the present processing is terminated.

In the third embodiment as described above, each touch sensor 99 included in the non-contact type third touch panel 98 detects each of the approach or proximity information and contact information from the magnitude of the capacitance change AC produced when the finger tip portion of the operator 2 approaches. The button array image 35 is displayed in enlarged form upon its approach, and each button is specified or identified upon its contact. It is therefore possible to reliably identify the button in one proximity operation by one sheet of touch panel and to input the operation or control information.

Although, in the third embodiment 3, the button image enlargement device 112 has displayed the enlarged image 71 enlarged with the proximity position in the button array image 35 as the center in such a manner that the center thereof assumes the proximity position, the center thereof can also be set to the center of the display screen.

Many widely different embodiments of the invention may be configured without departing from the spirit and the scope of the present invention. It should be understood that the present invention is not limited to the specific embodiments described in the specification, except as defined in the appended claims.

1. An operation information input apparatus comprising:
a button image display device configured to display a button array image with a plurality of button images arranged therein;
a touch panel device which is overlaid on a display surface of the button image display device, said touch panel device configured to detect proximity position information indicative of each position in the display surface when an operator approaches the display surface; and
a push button identifying unit configured to identify each button image that the operator has approached, based on the proximity position information and button position information of the button array image, wherein the button position information includes information of determination areas each obtained by reducing each button area with the button image located therein in a direction of a center of the button area from a boundary of the button area, and wherein said push button identifying unit is configured to perform the identification when a proximity position of the proximity position information is included in the corresponding determination area, and to perform the identification when the proximity position thereof is not included in the determination area.

2. The operation information input apparatus according to claim 1, wherein said push button identifying unit comprises a button image enlargement device configured to display the button image located in a neighborhood of the proximity position on said button image display device in enlarged form when the proximity position of the proximity position information is not included in the determination area.

3. The operation information input apparatus according to claim 2, wherein said push button identifying unit comprises an initial image resetting device configured to erase the enlarged button image display and and to display the button array image when the input of the proximity position information is not conducted during a predetermined time after the display of the enlarged button image display.

4. The operation information input apparatus according to claims 2, wherein said push button identifying unit comprises an enlargement factor setting device configured to set an enlargement factor upon the display of the enlarged button image display.

5. The operation information input apparatus according to claim 1, wherein said push button identifying unit comprises a re-proximity urging device configured to urge the operator to re-approach when the proximity position of the proximity position information is not included in the determination area.

6. The operation information input apparatus according to claim 5, wherein said re-proximity urging device comprises a warning sound generation device configured to product a warning sound for urging re-proximity.

7. The operation information input apparatus according to claim 5, wherein said re-proximity urging device comprises a follow-up character generation device configured to display a character for urging re-proximity on, said button image display device.

8. An operation information input apparatus comprising:
a button image display device configured to display a button array image with a plurality of button images arranged therein;
a touch panel device which is overlaid on a display surface of the button image display device, said touch panel device configured to detect proximity position information indicative of each position in the display surface when an operator approaches the display surface; and
a push button identifying unit configured to identify each button image that the operator has approached, based on the proximity position information and button position information of the button array image, said push button identifying unit comprising:
a button image enlargement device configured to display the button array image on said button image display device in enlarged form simultaneously with a first detection of the proximity position information, which is conducted when the button array image is displayed on said button image display device; and
a position information comparing device configured to identify each button image that the operator approaches, based on the proximity position information and the button position information of the button array image displayed in enlarged form, simultaneously with a second detection of the proximity position information, which is conducted after the first detection.

9. The operation information input apparatus according to claim 8, wherein said push button identifying unit comprises an initial image resetting device configured to stop the enlarged button image display and to display the button array image again.

10. An operation information input apparatus comprising:
a button image display device configured to display a button array image with a plurality of button images arranged therein;
a first touch panel device which is overlaid on a display surface of said button image display device, said first touch panel device configured to detect first proximity position information indicative of each position in the display surface when an operator approaches the display surface;
a second touch panel device which is overlaid on a panel surface of said first touch panel device, said second touch panel device configured to detect second proximity position information indicative of each position in the panel surface when the operator approaches the panel surface; and
a push button identifying unit configured to display the button array image in enlarged form, based on the first or second proximity position information and to identify each button image that the operator approaches, based on the second or first proximity position information detected after the enlargement display, and button position information of the button array image displayed in enlarged form.

11. The operation information input apparatus according to claim 10, wherein said first touch panel device comprises a non-contact type first touch panel.

12. The operation information input apparatus according to claim 11, wherein said second touch panel device comprises a contact type second touch panel.

13. The operation information input apparatus according to claim 11, wherein said second touch panel device comprises a non-contact type second touch panel.

14. The operation information input apparatus according to claim 13, wherein said first touch panel device comprises a detection signal sorting device configured to output a first proximity signal indicative of proximity of the operator when a magnitude of a detection signal of a touch sensor for detecting the proximity of the operator through said first touch panel exceeds a first threshold value.

15. The operation information input apparatus according to claim 14, wherein said detection signal sorting device is configured to output a second proximity signal indicative of proximity of the operator when a magnitude of a detection signal of a touch sensor for detecting the proximity of the operator through said second touch panel exceeds a second threshold value.

16. The operation information input apparatus according to claim 15, wherein the first threshold value and the second threshold value have different values respectively.

17. The operation information input apparatus according to claim 15, wherein said detection signal sorting device is configured to change the first and second threshold values according to each position in the display surface.

18. An operation information input apparatus comprising:
a button image display device configured to display a button array image with a plurality of button images arranged therein;
a third touch panel device which is overlaid on a display surface of said button image display device, said third touch panel device configured to detect proximity position information indicative of each proximity position in the display surface when an operator approaches the display surface; and
a push button identifying unit configured to identify each button image that the operator has approached, based on the proximity position information and button position information of the button array image,
wherein said third touch panel device comprises a proximity position detecting unit configured to determine the proximity position using a touch sensor for detecting the approach on a non-contact basis and a detection signal of said touch sensor,
wherein said third touch panel device comprises a detection signal sorting device configured to output a third proximity signal indicative of a first proximity and a fourth proximity signal at closer proximity than the first proximity, and
wherein said push button identifying unit comprises:
a button image enlargement device configured to display the button array image in enlarged form when the third proximity signal is received; and
a position information comparing device configured to identify each button image that the operator approaches, based on the proximity position information and the button position information of the button array image displayed in enlarged form.

19. The operation information input apparatus according to claim 18, the further comprising a detection signal sorting device configured to change a third threshold value for selecting the third proximity signal and a fourth threshold value for selecting the fourth proximity signal, according to each position in the display surface.

20. An ultrasonic imaging apparatus, comprising:
an input unit configured to input operation information of an operator therein;
a tomographic image acquisition unit configured to acquire tomographic image information of a subject, based on the operation information; and
a display unit configured to display the tomographic image information thereon, wherein said input unit comprises an operation information input apparatus comprising:
a button image display device configured to display a button array image with a plurality of button images arranged therein;
a touch panel device which is overlaid on a display surface of the button image display device, said touch panel device configured to detect proximity position information indicative of each position in the display surface when an operator approaches the display surface; and
a push button identifying unit configured to identify each button image that the operator has approached, based on the proximity position information and button position information of the button array image, wherein the button position information includes information of determination areas each obtained by reducing each button area with the button image located therein in a direction of a center of the button area from a boundary of the button area, and wherein said push button identifying unit is configured to perform the identification when a proximity position of the proximity position information is included in the corresponding determination area, and to perform the identification when the proximity position thereof is not included in the determination area.
